(19) United States
(12) Patent Application Publication
(10) Pub. No.: US 2007/0028275 A1
(43) Pub. Date: Feb. 1, 2007

(54) Method and system for still image channel generation, delivery and provision via a digital television broadcast system

(76) Inventor: Neil Alistair Lawrie, Katoomba (AU)

Correspondence Address: GRAYBEAL, JACKSON, HALEY LLP, 155 - 108TH AVENUE NE, SUITE 350, BELLEVUE, WA, 98004-5901, US

(21) Appl. No.: 11/487,163

(22) Filed: Jul. 13, 2006

Related U.S. Application Data
(63) Continuation of application No. PCT/AU05/00031, filed on Jan. 13, 2005.

(30) Foreign Application Priority Data
Jan. 13, 2004 (AU) 2004900119

(51) Int. Cl. H04N 7/173

(52) U.S. Cl. 725/93

(57) ABSTRACT

Methods and systems for the generation, delivery and presentation of interactive slideshow channels via a digital broadcast system are provided. In one form, each slideshow channel resembles a television channel except channel content comprises a sequence of still images, which may be synchronized to an audio channel, and which may have interactive functionality. A plurality of discrete event packets of data are generated, broadcast and received and processed in the systems and methods, each packet including data representing at least one of passive content to be output to a multimedia device, and interactive content to be output to the multimedia device on request by a viewer of the multimedia device. Each packet further includes a time stamp for determining when the content should be made available for output to the multimedia device.

### PRIORITY CLAIM

This application claims priority from PCT Patent Application No. PCT/AU2005/000031, filed Jan. 13, 2005, which claims priority from Australian Patent Application No. 2004900119, filed on Jan. 14, 2004, both of which are incorporated herein by reference.

### FIELD OF THE INVENTION

The present invention relates to methods and systems for generation, delivery and presentation of interactive content, such as slide shows, using a digital television broadcast system.

### BACKGROUND ART

In the current environment, digital broadcast television systems support the simultaneous broadcast of video, audio and data content from a central transmission site to a plurality of remotely located receive sites. Digital broadcast systems transmit multimedia content as streams of digital data over a transmission medium. Examples of transmission media include satellite, cable, terrestrial wireless and fixed line telephony networks. The amount of broadcast media bandwidth consumed rises with the complexity of the multimedia content transmitted.

Each digital broadcast system receive site includes a digital decoder that manages the receipt and presentation of received multimedia content to the viewer. The digital decoder typically includes a digital processor and computer memory, which are capable of supporting software applications that enable the viewer to interact with the received broadcast multimedia content.

In the current environment, digital broadcast television channels are expensive to produce and deliver, thereby prohibiting many individual organisations from operating their own channel. One major expense of digital broadcast systems is the cost of bandwidth required to send video content through the broadcast system as video images are required to be broadcast many times per second in order to maintain and update a continuous visual display to the viewer.

The above discussion of background art is included to explain the context of the present invention. It is not to be taken as an admission that any of the material referred to was published, known or part of the common general knowledge at the priority date of any one of the claims of this specification.

### SUMMARY OF THE INVENTION

Methods and systems for the generation, delivery and presentation of interactive slideshow channels via a digital broadcast system are provided. In one form, each slideshow channel resembles a television channel except channel content comprises a sequence of still images, which may be synchronized to an audio channel, and which may have interactive functionality. Content for each slideshow channel is preferably broadcast only at intervals greater than one second. Therefore, individual channels can be produced and delivered for a fraction of the cost of a video channel.

Once selected by a viewer, slideshow channels require no further interaction from the viewer to maintain a continual flow of visual and/or audio content to the viewer. Slideshow channel interactive functionality may include the ability for viewers to navigate between still frames and also access additional still frames and other content that is not available to a passive viewer of the channel. In one form, the system employs an interactive application to present content to viewers and a single interactive application may support multiple slideshow channels, thereby enabling application bandwidth overhead to be shared across multiple slideshow channels. Slideshow channel content may be broadcast separately from the interactive application and only broadcast once rather than on a cycle, thereby enabling broadcast quality content to be distributed at low bandwidth. Content for multiple slideshow channels may be multiplexed onto a single data channel thereby further optimising data channel bandwidth usage. Content for each slideshow channel may be broadcast to digital decoders by way of an ordered sequence of self-contained discrete event packets of data, which are typically broadcast at variable intervals of greater than one second. Channel content may either be pre-scheduled by way of an authored channel schedule or comprise live audio and/or visual content. Each event packet may include a time stamp that represents the preferred time at which passive content, in embodiments in the form of a still frame, will be made available to the viewer. Data packets for pre-scheduled channels may be sent out ahead of time thereby enabling time synchronization to be maintained over networks with variable latency. Viewer interactivity may be defined in each data packet thereby enabling interactive functionality to be dynamically assigned on a frame-by-frame basis. The interactive slideshow channel system does not require a modem return path and may operate in isolation of video channels and other interactive applications. Optional functionality allows the system to interact with video and external applications if they are present either directly or via a modem return path.

In one form, viewers select individual slideshow channels by way of a channel number, menu, electronic program guide, video channel, interactive icon, or third party application. Once selected, each channel requires no further viewer interaction to maintain a flow of passive push content to the viewer. Each channel may also offer viewers interactive functionality that is uniquely associated with each still frame. Applications for the invention include enabling organizations to establish low cost interactive push television channels and enabling audio services to add an interactive visual dimension.

In one form of the invention, channels are delivered via a digital broadcast system and presented to the viewer via a television. In one form of the invention, the digital broadcast system is a broadcast television system that delivers video, audio and data content to multiple dispersed digital television decoders (set-top boxes) installed with an interactive television operating system.

A broadcast system of one form of the invention includes three main functional components: a channel generating means in the form of a channel generator, channel managing means in the form of a channel manager and a client application generator. In one form, the channel generator includes a distributed computer software application that enables channel administrators to program the order and timing of multimedia content to be presented on each slideshow channel. In one form, the channel manager is a centralised software application that aggregates content received from multiple channel generators onto one or more multiplexed data channels for distribution to viewers via the digital broadcast system. In one form, the client application generator provides a client application, which is software that runs on the viewer set-top box digital decoder or similar device to manage all interaction with the viewer and to present slideshow channel content to the viewer on a TV or similar device. A single client application may support any number of slideshow channels.

The method of one form of the invention uses separate processes to deliver the client application and the slideshow channel multimedia content. In one form, the client application either resides in the digital decoder, set-top box, or similar device or is broadcast on a continual cycle and is subsequently loaded into RAM of the digital decoder when required. In one form, all slideshow channel multimedia content is delivered by way of a chronological sequence of self-contained discrete event packets of data. Each event packet may include a channel identifier, a time-stamp, and passive and interactive multimedia content. All event packets including all bulky still images preferably only need be broadcast once, with content for all channels aggregated onto one or more multiplexed data channels thereby minimising bandwidth consumption. This approach allows an individual slideshow channel, sharing a cycled client application, and presenting a continuously changing sequence of broadcast quality stills and audio with interactive functionality, to be delivered using as little as 100 kbps in average total data bandwidth per channel. In comparison, broadcast quality video channels can consume as much as 6 Mbps per channel. In addition, existing non-video applications require still images to be broadcast continuously on a cycle, or require viewer interaction to select still images for display or do not allow the inclusion of live multimedia content or do not allow viewer interaction with individual still images or do not allow the synchonisation of visual still images to audio.

According to one form of the invention, the client application is automatically loaded into RAM of the digital decoder whenever a viewer selects a slideshow channel by one of the available methods, noting that the application itself also provides a method for viewers to select slideshow channels. Once a channel is selected, the client application refers to an internally stored table to retrieve static data related to that channel. This data may be used by the client application to present the viewer with a start-up screen that identifies the channel. The table may also be used to identify which audio channel is to be synchronised with the slideshow channel (if any) and which multiplexed data channel is broadcasting event packets for that channel. The client application then tunes to the appropriate channel and filters out and stores in memory any received event packets that include channel identifiers that match that of the selected channel. In one form, for newly selected channels, there will be a delay before the first event packet is presented to the viewer, due to the time delay between the broadcast of each unique packet.

In one form of the invention, the client application processes each received event packet at the time defined in the time-stamp. The client application then extracts passive multimedia content from the event packet, such as a still image, and presents it to the viewer. This passive content remains on display until overlaid by new passive content associated with a subsequent event packet for that channel. In this way, each channel presents the viewer with a continually changing display of passive slideshow content without any requirement for a return path or viewer interaction.

According to one form of the invention, the client application includes a generic superset of available viewer interactive functionality for use with slideshow channels. The client application may then use an interactive content definition within the interactive content in an event packet to determine the unique subset of interactive functionality to be made available to the viewer for that event packet. This approach enables viewer interactivity to be dynamically adjusted for each broadcast still frame presented in a slideshow channel. Event packets may also include channel-specific data references and multimedia content files required to support the defined interactive functionality, with this data presented by the client application in response to viewer interaction. Interactive functionality may enable the viewer to, for example, freeze the channel on a current still frame, rewind and fast-forward between passive still frames, access hidden still frames, which may also be included in the interactive content and other multimedia content associated with a specific passive still frame or complete text searches. A viewer may also be able to access third party applications, such as a remote web site, through an optional return path.

According to one form of the invention, slideshow channel multimedia content may be either pre-scheduled or live and be generated through a computer application or sourced from input devices such as a still camera and/or microphone. For pre-scheduled channels, the channel generator may provide a user interface that enables administrators to predefine, for each slideshow channel, a schedule of chronological time-stamped event packets with accompanying references to stored multimedia content files. All schedules and associated content files may then be sent ahead of time for storage on the channel manager. The channel manager may continually read event packet timestamps for all active schedules and broadcast event packets to the client application in advance of their time-stamp. This approach allows variable network delays to be accounted for and also enables slideshow channels to always be accurately synchronized with an associated audio channel, if provided. For live channels, the channel generator may manage the collection of live content from input devices and then build event packets that are sent immediately through to the channel manager via a data circuit for broadcast distribution. The channel manager may use mathematical algorithms to manage the multiplexing of all event packets so that latency is minimized for newly selected channels and overall data bandwidth is optimised.

Therefore, according to a first embodiment of the invention, there is provided a method of broadcasting an image channel over a digital television broadcast network for output by a multimedia device, the method including broadcasting a plurality of discrete event packets of data, each packet including data representing at least one of passive content to be output by the multimedia device, and interactive content to be output by the multimedia device on request by a viewer of the device, wherein each packet further includes a time stamp for determining when the content should be made available for output to the multimedia device.

According to a second aspect of the invention, there is provided a method of generating an image channel for broadcast on a digital television broadcast system for output by a multimedia device, the method including receiving channel content, defining content as at least one of passive content and interactive content, wherein the passive content is configured to be output by the multimedia device, and the interactive content is configured to be output by the multimedia device on request by a viewer of the multimedia device, splitting the content into discrete units, associating the content of each unit with a time stamp for determining a desired time for the content of the unit to be made available for output to the multimedia device, and generating and outputting for broadcast discrete event packets of data, each event packet containing data representing at least one unit of at least one of passive and interactive content, and the associated time stamp.

According to a third aspect of the invention, there is provided an image channel generation system for a digital television broadcast network for output by a multimedia device, the system including at least one generating means, each of which includes a receiving component for receiving image channel content, a defining component for defining content as at least one of passive content and interactive content, wherein the passive content is configured to be output by the multimedia device, and the interactive content is configured to be output by the multimedia device on request by a viewer of the multimedia device, a splitting component for splitting the content into discrete units, an association component for associating the content of each unit with a time stamp for determining a desired time for the content of the unit to be made available for output to the multimedia device, and a generating component for generating and outputting for broadcast discrete event packets of data, each packet containing data representing at least one unit of at least one of passive and interactive content, and the associated time stamp.

According to a fourth aspect of the invention, there is provided a method of processing an image channel from a digital television broadcast network for output to a viewer of the channel for output by a multimedia device, the method including receiving a plurality of event packets of data, each packet including data representing a time stamp and at least one of passive content and interactive content, wherein the passive content is configured to be output by the multimedia device, and the interactive content is configured to be output by the multimedia device on request by a viewer of the multimedia device, determining the time that the content of each packet should be made available for output using the time stamp, and making the content of the packet of the image channel available for output to the viewer at the determined time.

According to a fifth aspect of the present invention, there is provided receiving device for receiving an image channel broadcast on a digital television broadcast network for output by a multimedia device, the device including receiving means for receiving discrete event data packets, each packet including a time stamp and at least one of passive content and interactive content, wherein the passive content is to be made available for output by the multimedia device, and the interactive content is to be made available for output by the multimedia device on request by a viewer of the device, processing means for processing the discrete event data packets, and outputting means for outputting the content to be available for output by the multimedia device to a viewer at the time indicated by the associated time stamp.

According to a sixth aspect of the present invention, there is provided a receiving device for receiving a channel broadcast on a digital broadcast network, the device including receiving means for receiving discrete event packets of data, each packet including content and an associated time stamp, processing means for processing the discrete event packets, and outputting means for making the content available for display by a multimedia device at the time indicated by the associated time stamp.

According to a seventh aspect of the present invention, there is provided a method of processing digital broadcast channels received from a digital broadcast network for presentation, the method including receiving a plurality of event packets of data, each event packet including data representing content and an associated time stamp, and outputting the content for display at the time indicated by the associated time stamp.

According to an eighth aspect of the present invention, there is provided a method of broadcasting channel over a digital broadcast network, the method including broadcasting a plurality of discrete event packets of data, each packet including data representing content to be made available for output by a multimedia device, and an associated time stamp for determining when the content should be made available for output to the multimedia device.

According to a ninth aspect of the present invention, there is provided a method of configuring a receiving device for receiving a channel broadcast on a digital network, the method including, receiving client application software at the receiving device, installing the client application software on the receiving device, and running the client application software on the receiving device, wherein the client application software includes instructions to carry out the method according to any one of the fourth and eighth aspects of the invention.

According to a tenth aspect of the invention, there is provided a method of optimising bandwidth in a digital broadcast network broadcasting multiple channels, the method including receiving a plurality of discrete event packets of data, each event packet including data representing content for a channel, and an associated time stamp for determining when the content should be made available for output to a viewer by a multimedia device, determining the size of each event packet and a time represented by the associated time stamp, and determining an optimum broadcast time for each event packet, wherein the optimum broadcast time is the latest time that the event packet can be broadcast and be processed by the multimedia device before the time represented by the associated time stamp.

### DESCRIPTION OF THE DRAWINGS

Specific embodiments of the invention will now be described, purely by way of example, with reference to the accompanying drawings, in which:

FIGS. 1a and 1b are block diagrams showing an interactive slideshow channel system including systems of embodiments of the invention;

FIG. 2 shows a breakdown of event packet components used in an embodiment of the invention;

FIG. 3 is a flowchart showing processes carried out in a channel generator of a system according to an embodiment of the invention;

FIG. 4 is a flowchart showing processes carried out in a channel manager of a system according to an embodiment of the invention;

FIG. 5 is a flowchart demonstrating slideshow channel selection methods in a system according to an embodiment of the invention;

FIG. 6 is a flowchart demonstrating a process for loading slideshows in a system according to an embodiment of the invention;

FIG. 7 is a flowchart demonstrating client application processes in a system according to an embodiment of the invention;

FIG. 8 is a flowchart demonstrating event packet processing in a system according to an embodiment of the invention;

FIGS. 9 & 10 are flowcharts demonstrating viewer interactive functionality in a system according to an embodiment of the invention; and

FIG. 11 is a flowchart demonstrating viewer interactivity navigation processes in a system according to an embodiment of the invention.

### DETAILED DESCRIPTION OF PREFERRED EMBODIMENTS

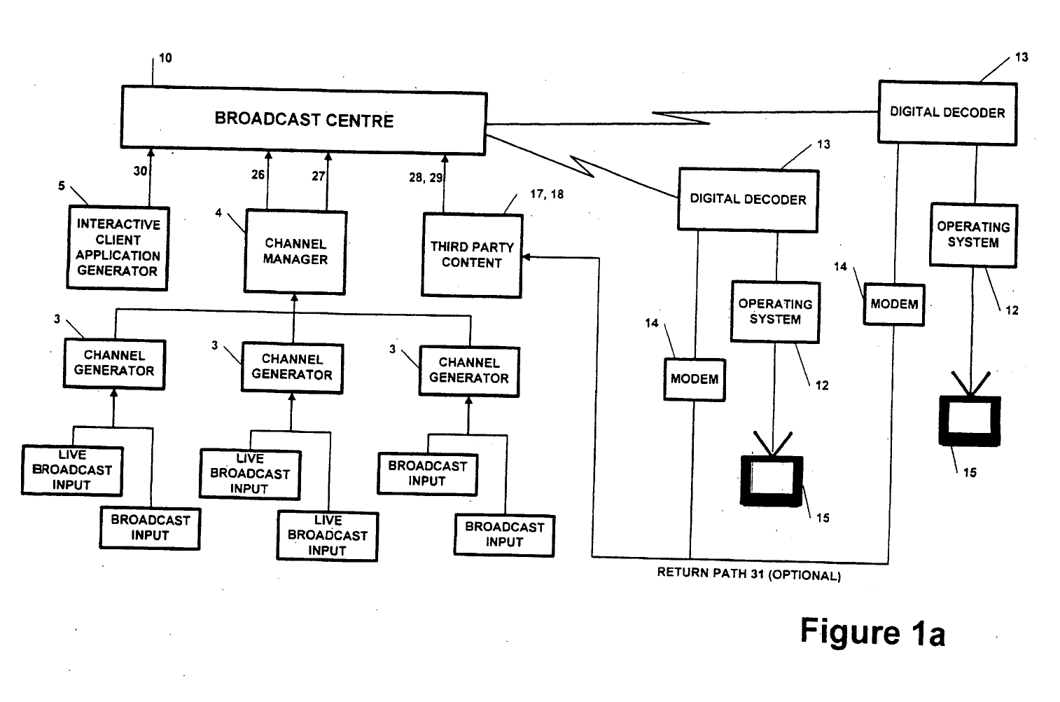

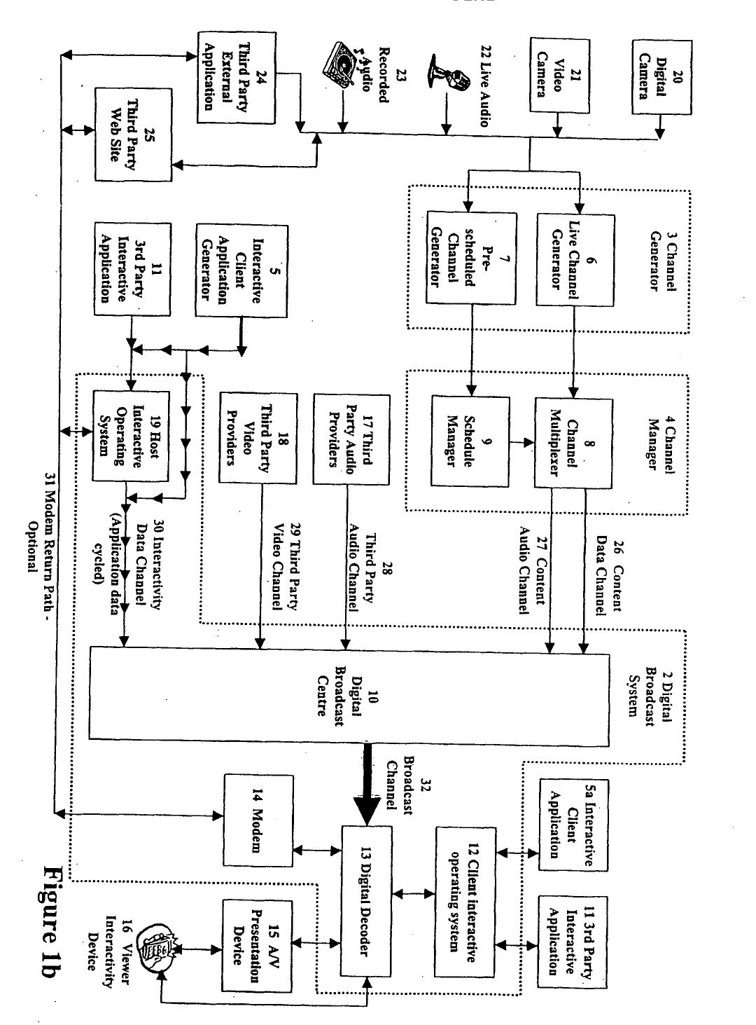

FIG. 1a is a block diagram of an interactive slideshow system including systems of embodiments of the invention. The interactive slideshow channel system is a system for the generation, broadcast delivery and simultaneous presentation of interactive audio-visual slideshow channels on multiple remote multimedia devices in the form of audio-visual display devices, in the present embodiment televisions 15.

FIG. 1a, shows, schematically, the block elements in an interactive slideshow system according to an embodiment of the invention. The interactive slideshow channel system employs a digital broadcast system to effect the broadcast digital transmission of data to multiple receiving locations.

Three modules are provided, which control the content of the interactive slideshow channels. These modules are: a channel generator 3, which controls the generation of slideshow channels; a channel manager 4, which controls the broadcast of slideshow channels; and an interactive client application generator 5, which provides client applications to be run locally at a digital decoder.

The digital television broadcast system includes a broadcast centre 10, which accepts multimedia data streams from external sources and then multiplexes this data onto one or more broadcast channels 32 for transmission through a broadcast medium to a dispersed set of remotely located receiving devices in the form of digital decoders 13. Each digital decoder 13 includes receiving means, processing means and outputting means. The multimedia data streams may be video, audio, data or any combination of these multimedia formats. The digital television broadcast system may include any working broadcast medium 32 including, but not limited to satellite, cable, terrestrial and telephone circuits. By digital broadcast system what is meant is any system that operates to enable the simultaneous one-way transmission of digital multimedia content from a central transmission site to multiple dispersed receive sites.

Each digital decoder 13 is connected to one of the televisions 15, which effects the presentation of multimedia content to viewers. The multimedia device may alternatively be a suitably configured personal computer or other device capable of outputting the data broadcast by the digital television broadcast system. Viewers may interact with both their digital decoder 13 and their television 15 through one or more remote controls. The digital decoders 13 therefore also include interactive means, which receive interactive control signals from the remote control unit of the viewer and act on the desired interactivity.

Each digital decoder 13 may be fitted with an internal or external modem 14 to provide a modem return path 31. A modem 14 and modem return path 31 are not essential to the invention and are only included in some embodiments in order to support some optional interactive functionality.

Each digital decoder 13 in the digital television broadcast system is, in the present embodiment, loaded with a client interactive operating system (although this need not be essential in all embodiments), which supports interactive applications that include both the client application provided from the client application generator 5 and other third party interactive applications. The client interactive operating system and interactive applications may permanently reside in the digital decoder 13 on storage means such as hard disk/static memory or be sourced via a network from an external device. The client interactive operating system may be updated from a host interactive operating system via the modem return path 31 if available, or via the broadcast centre 10 through the broadcast channel 32. The client application and third party interactive applications, discussed below, may be delivered through the modem return path 31, if available, or be continuously broadcast on a cycle by the broadcast centre 10 through the broadcast channel 32.

The broadcast centre 10 receives different channels, including a content data channel 26; a content audio channel 27, which is associated with the content data channel 26 in the present embodiment; third party video, audio, and data channels 28, 29; and the interactive data channel 30, from the respective providers and broadcasts them all on the broadcast channel 32.

In the present embodiment, the digital broadcast system is a digital television broadcast system, whereby the broadcast centre 10 is a broadcast television centre, the broadcast medium is an MPEG2 broadcast medium. In this case, the client interactive operating system is a digital television operating system and third party interactive applications could include an electronic program guide (EPG). The digital television broadcast system accepts the third party video, audio and data channels 28, 29 and transmits these through the broadcast channel 32 to remote digital decoders 13. Note that an accompanying video/television channel is not essential to the invention and is employed in some embodiments to support some optional functionality.

As illustrated in FIG. 1b, which shows the functional building blocks of the system of FIG. 1a, the generation and management section of the system includes three modules that effect the generation, broadcast delivery and presentation of interactive slideshow channels through the digital broadcast system 2. These modules are the channel generator 3, channel manager 4 and client application generator 5. The system includes a defining component, which determines whether the content is to be defined as passive or interactive and defines it as such. A splitting component is provided to split the content into discrete units, and an association component for associating the content of each unit with a time stamp for determining a desired time for the content that each unit should be made available to the television 15. A generating component is provided, which generates event packets of data, containing content and the associated time stamp. The generating means may include the channel generator and the channel manager, or only one of them.

The channel generator 3 is a computer-based application used by channel administrators to define the nature and timing of multimedia content to appear on interactive slideshow channels. Each channel administrator is responsible for programming content for one or more slideshow channels. A separate channel generator 3 is provided for control of each interactive slideshow channel. Alternatively, a single channel generator may be used to generate multiple channels. The channel generators 3 may be either dispersed and loaded as a standalone application on a computer at the site of any channel administrator or centrally located and accessed by multiple channel administrators through data networks such as a Local Area Network (LAN) or the Internet.

Each channel generator 3 allows channel administrators to prepare both pre-scheduled and live content for distribution on a slideshow channel. The channel generator 3 includes a receiving component, which receives content including still images, audio, graphics, animation and text. This content may be either created directly from connected external multimedia devices including a digital camera 20, video camera 21, live audio 22, recorded audio 23 or sourced from a third party external application 24 or third party web site 25.

The channel generator 3 includes both a live channel generator 6 and a pre-scheduled channel generator 7. The live channel generator 6 provides a user interface that enables channel administrators to configure and source content for live channels as well as define interactive functionality. The live channel generator 6 splits the content into discrete units and builds live event packets, as discussed below, and transfers these to the channel manager 4 continuously via a data circuit. The pre-scheduled channel generator 7 also splits the content into discrete units and provides a user interface that enables channel administrators to prepare schedules of interactive event packets, discussed below, for pre-scheduled channels. The pre-scheduled channel generator 7 sends completed schedules for interactive event packets along with all associated content through to the channel manager 4 for storage and processing.

The channel manager 4 is a centralised software application that centrally manages all slideshow channel content delivered through the interactive slideshow channel system 1. The channel manager 4 receives channel schedules and content event data from multiple dispersed channel generators 3 and multiplexes all received content onto one or more content data channels 26. The channel manager 4 also establishes and maintains a channel information table that configures default parameters for each channel. The channel information table is replicated and used by the client application 5a.

The channel manager 4 includes a channel multiplexer 8, and a schedule manager 9. The channel multiplexer 8 interfaces with all live channel generators 6 to accept and store live event data. The schedule manager 9 accepts and stores schedules for all pre-scheduled channels received from pre-scheduled channel generators 7. The schedule manager 9 processes each schedule and, in the case of pre-scheduled channels, constructs event packets. The event packets are then passed on to the channel multiplexer 8. The channel multiplexer 8 prioritises and queues event data received from the schedule manager 9 and all live channel generators 6 onto one or more multiplexed content data channels 26 output from the channel multiplexer 8 of the channel manager 4. The channel manager 4 may encrypt event data. The channel multiplexer 8 uses mathematical algorithms to order and prioritise content event data to optimise bandwidth use and maintain channel synchronization.

The channel multiplexer 8 uses a bandwidth optimisation algorithm to order and prioritise content event packets broadcast on each data channel 26 and thereby maintain channel synchronization and optimise bandwidth usage. The bandwidth optimisation algorithm seeks to broadcast live packets as soon as possible to the time at which they were received by the channel manager. The bandwidth optimisation algorithm also seeks to ensure that all pre-scheduled event packets arrive at the client application before their timestamp, whilst taking into account latency associated with broadcast transmission and broadcast system and decoder processing. The bandwidth algorithm will attempt to broadcast pre-scheduled event packets as close as possible to a timestamp for that packet (described in more detail below) in order to minimise the delays experienced by viewers before they receive live content after they first select the channel.

The bandwidth optimisation algorithm is applied to each data channel 26. The algorithm continually reviews all active channel schedules to determine the timestamp and size of the next event packet to be broadcast for each active channel. For each pre-scheduled event packet, the algorithm assigns an optimum broadcast time, which represents the latest time at which that event packet can be broadcast and still arrive at the decoder in adequate time to be processed and presented to the multimedia display device at the time specified by the timestamp.

The algorithm continually reviews the number and size of all packets queued in event packet memory. The algorithm assigns an optimum broadcast time as the current time for each of these event packets. The algorithm also continually refers to the channel information table to determine the priority level assigned for each channel associated with one of the above event packets and configuration data such as system latency and data channel bandwidth. Further, the algorithm makes dynamic decisions as to the nature and timing of the next event packet to be broadcast on the data channel. If there is no contention between broadcast times for event packets, the algorithm broadcasts each event packet at its corresponding optimum broadcast time.

If there is contention between pre-scheduled event packets, the algorithm assesses available bandwidth and brings forward the assigned broadcast time for event packets with a lower priority so that all pre-scheduled event packets are broadcast in time to be received at the decoder ahead of their timestamp. If there is contention between pre-scheduled event packets and live event packets, the algorithm assesses available bandwidth and based on channel priority levels either brings forward the broadcast time for pre-scheduled event packets or delays the broadcast time for live event packets such that all pre-scheduled event packets are broadcast in time to be received at the decoder ahead of their timestamp. The algorithm continually monitors the level of traffic through the event packet memory and uses this to predict future traffic and thereby optimise the future assignment of broadcast times for pre-scheduled and live event packets

The channel manager 4 may also transmit audio channels associated with live or pre-scheduled slideshow channels through a content audio channel 27 output from the channel multiplexer 8.

The client application generator 5 initiates the broadcast of the interactive client application 5a via one or more data channels broadcast by the broadcast system 2, and loaded on the digital decoder 13 to effect the presentation of slideshow channels to a viewer of the connected television 15. A single client application 5a can support multiple slideshow channels. Individual slideshow channels can be selected via a variety of means, one of which is through a menu provided by the client application 5a. Once a channel is selected, the client application 5a tunes to the appropriate content data channel 26 and content audio channel 27 or third party audio channel 29 for the selected channel and commences filtering all related event packets. The client application 5a processes and presents content for event packets on the television 15 at the time nominated in the particular event packet. The client application 5a also manages all interactivity with the viewer via the remote control 16 according to the functionality defined in the event data. Optional interactive functionality may involve the client application 5a sourcing and presenting content from a third party external application 24 or a third party web site 25 through the modem return path 31, if available.

In the present embodiment of the invention, an interactive slideshow channel resembles a standard television channel, except the visual content comprises still images rather than video. Slideshow channels present themselves as a changing sequence of still images synchronized to audio. Slideshow channels are generated and distributed as a sequence of self-contained store and forward multimedia event packets on a data channel. Unlike video channels, which require a continual stream of video data to maintain a presence on a remote television screen, new slideshow channel event packets are only sent out every few seconds with existing visual content maintained on the television until updated by newly arrived visual content. This technique enables slideshow channels to broadcast high quality content at greatly reduced bandwidth consumption. Slideshow channels require no viewer interaction to present a changing flow of push multimedia content, but slideshow channels have the option to offer interactive functionality that enables viewers to manipulate the content that appears on the channel.

The client application 5a itself is independent of broadcast channel content. In the present embodiment of the invention, the client application 5a is an interactive television application that is continuously broadcast on a cycle via the interactivity data channel 30 and only loaded into digital decoder memory 13 when required. In contrast, channel content files for each slideshow channel, including large still image files, are broadcast only once on the content data channel 26.

This approach of broadcasting bandwidth heavy content only once, of multiplexing content for multiple channels onto one content data channel 26 of optimising bandwidth consumption and sharing the bandwidth load of the client application 5a across multiple channels leads to significant bandwidth savings. As a result, an individual slideshow channel presenting broadcast quality stills, audio and other content and sharing a cycled client application is able to be broadcast using as little as 100 kbps in average total bandwidth per channel.

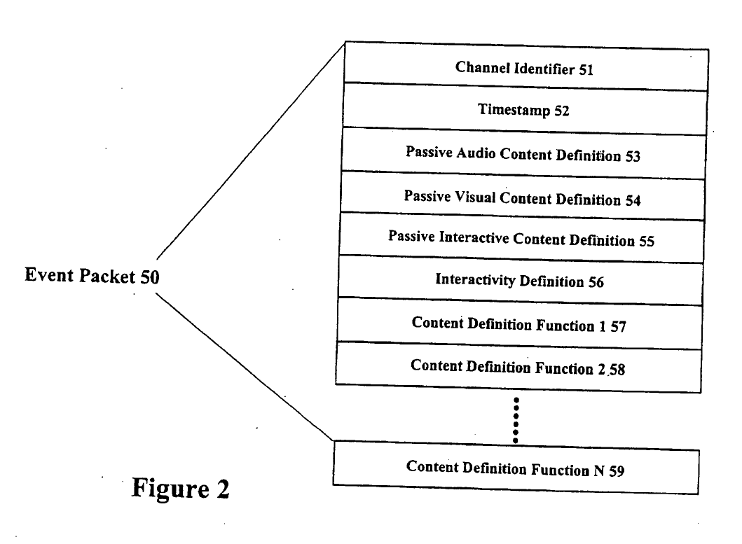

Data for interactive slideshow channels are delivered from the channel manager 4 through the digital broadcast system 2 to the digital decoder 13 by way of groups of associated data, conveniently described as self-contained discrete event packets 50, which are processed by the client application 5a. FIG. 2 shows a diagram that illustrates a breakdown of event packet components 50 broadcast on the system of FIGS. 1a and 1b.

All slideshow channels on the system are assigned a unique channel identifier 51, which is inserted into each event packet 50 and subsequently used by the client application (5a ref. FIG. 1b) to filter out, from a content data channel 26, event packets 50 belonging to the channel selected by the viewer.

Each event packet 50 includes a timestamp 52. The timestamp 52 defines the time at which the event packet 50 is to be processed by the client application 5a. At this time, the client application 5a presents the passive content included in the event packet 50 on the viewer's television 15.

Each event packet 50 includes a passive audio content definition 53, which defines how audio is to be presented to a passive viewer for that event packet 50 and also includes any associated audio files and reference data. According to the present embodiment of the invention, audio options include:
Override audio file: Instructs the client application to override existing audio with an included audio file.
Override audio channel: Instructs the client application to override existing audio with a defined audio channel.
Override default audio channel: Instructs the client application to override existing audio with the default audio channel. Note the client application assigns a default audio channel or no audio channel to all channels when they are launched, based on the channel information table.
Continue audio: Instructs the client application to do nothing and hence continue the existing audio, which may be an existing audio channel, a residual audio file sent in an earlier event packet 50 or silence.
Override silence: Instructs the client application to override existing audio with silence.

Each event packet 50 includes a passive visual content definition 54, which defines how visual content is to be presented to the viewer for that event packet 50. According to the present embodiment of the invention, visual options include:
Override visual content file(s): Instructs the client application to override existing visual content with one or more included visual content files such as a still image, graphics, animation and text.
Overlay visual content file(s): Instructs the client application to retain existing visual content and overlay one or more new included visual content files such as a still image, graphics, animation and text.
Override default channel screen: Instructs the client application to override existing visual content with the default channel screen. Note the client application assigns a default channel screen to all channels when they are launched, based on the channel information table.
Override blank screen: Instructs the client application to override existing visual content with a blank screen.

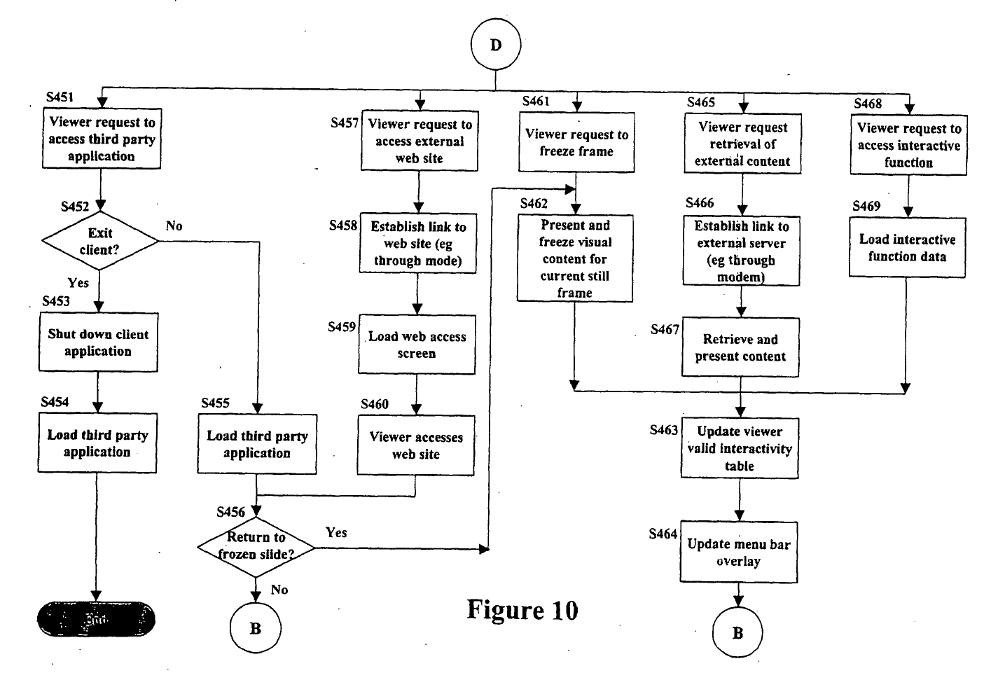

Each event packet 50 includes a passive interactive content definition 55, which defines the top level of viewer interactivity provided when the digital decoder displays passive slides (which are pushed from the broadcast centre), without any interaction from the viewer, herein called passive mode, as discussed in more detail below. When in passive mode, passive content is displayed, which content is referred to as frame level 0 within each packet. In this case, the viewer is presented with an interactive icon that overlays the passive visual content for the event packet 50. The interactive icon indicates to the viewer that interactive functionality is available for that event packet 50 and invites them to use their remote control 16 to move from passive mode into interactive mode, as discussed with reference to FIG. 9 below, and subsequently access either a menu of available interactive functionality options or a menu providing options relating to a specific interactive function. In the present embodiment of the invention, the passive interactive content definition 55 includes the following sub-fields:
Overlay interactive icon: Instructs the client application to overlay an interactive icon over the passive visual content. This may be a generic icon stored by the client application, an included icon file or no icon.
Freeze frame: Instructs the client application to freeze the current visual content on the audio-visual interactive device if the viewer selects the interactive icon. Newly arrived event packets 50 for that channel are stored by the client application, but not processed.
Deactivate audio: Instructs the client application to deactivate audio if the viewer selects the interactive icon.
Overlay menu: Instructs the client application to overlay a menu over the current visual content if the viewer selects the interactive icon. This may be a generic menu stored by the client application, an included menu file or no menu. The menu may allow the viewer to: select from a range of interactive functions; exit the client application; display the channel menu, load a new slideshow channel; or exit to passive mode, as discussed below with reference to FIG. 9.
Load interactive function: Instructs the client application to immediately run a specified interactive function if the viewer selects the interactive icon.

Each event packet 50 includes an interactive function definition 56, which defines the interactive functionality to be made available to the viewer for that event packet 50. A complete generic set of interactive functions available for use by all slideshow channels is defined within the client application 5a, along with all software code required to support this interactive functionality. Additional interactive functions may be added over time to extend this set by upgrading the client application 5a that is provided by the client application generator 5 and broadcast over the broadcast system. The interactive function definition field 56 in each event packet 50 then defines the specific subset of interactive functions to be made available to the viewer for that event packet 50. Through this approach, interactive functionality may be dynamically reassigned for individual slideshow channels on a frame-by-frame basis.

For each generic interactive function defined by the interactive function definition 56 as being made available to the viewer for a particular event packet 50, there will be a corresponding interactive content definition function field 59 in the event packet 50. Each interactive content definition field 59 defines content, configuration data and reference data that are unique to the slideshow channel event packet 50 in its implementation of that particular interactive function. Interactive functions may provide a wide variety of viewer interactivity and the interactive content definition field 59 defines how that particular interactivity will be presented to the viewer.

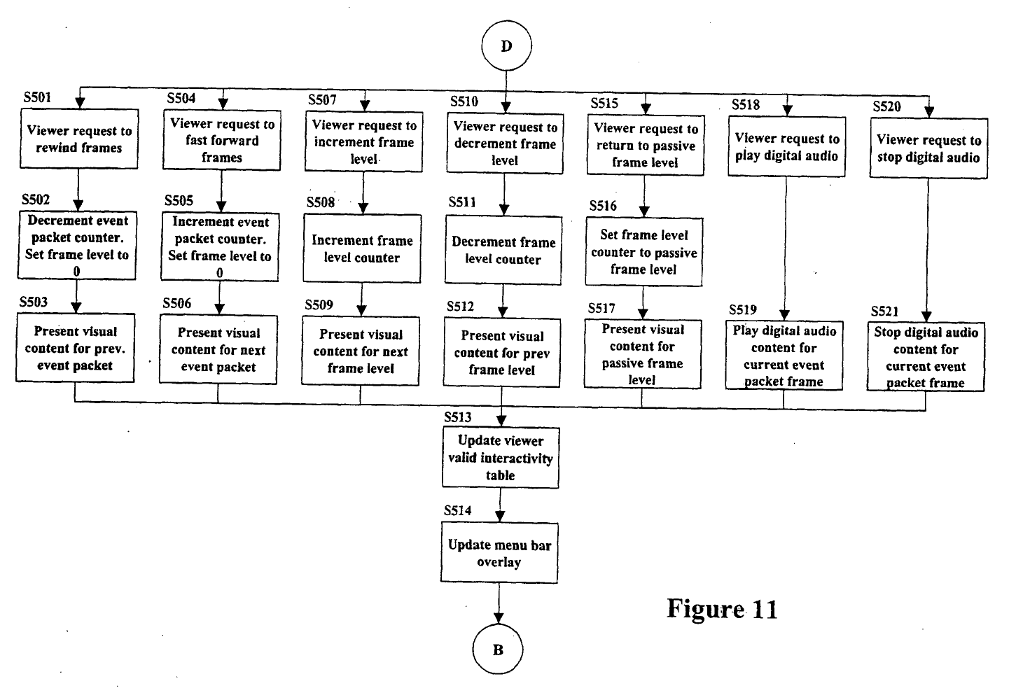

In one embodiment, a first interactive function (1) relates to providing the viewer with interactive content in the form of navigation features (as discussed below with reference to FIG. 11) that enable them to interactively move backwards and forwards between still frames presented on the channel and to access additional hidden (interactive) content included in each event packet 50. As mentioned above, when a viewer is watching a channel in passive mode, they are presented with passive content, which is defined for each event packet 50 in frame layer 0 through the audio content definition 53 and the visual content definition 54. If a second interactive function (2) is made available to the viewer for that event packet 50 and the viewer selects this interactive function from an interactive menu, the client application will freeze the visual content on the current still frame and then present a menu bar. The menu bar enables the viewer to move forwards and backwards through event packets and access hidden frames and other content associated with the current displayed frozen still frame. Alternatively, the passive content of new packets may continue to be output where the client application does not freeze; the interactive content may be overlayed on top of the passive content, which continues to update.

Hidden content may be in the form of still images, audio, graphics, text and animation and is arranged into frame levels 1-N. Each frame level includes its own set of audio, visual and interactive content definition fields and viewers are provided with menu bar options that enable them to move between event packets and frame levels. The interactive content definition function 57 field includes the structure of interactivity to be provided for that event packet 50 including the menu bar, the number of frame levels, the structure of content included in each frame level, and the interactivity provided and the associated content files themselves.

For live channels, the live channel generator 6 builds event packets 50 based on pre-configured intervals or an external trigger. When each event packet 50 is built, the live channel generator 6 automatically inserts the build time as the timestamp 52. When the event packet 50 is subsequently received by the client application, the event packet 50 is processed immediately as the current time is after the timestamp 52.

According to the present embodiment of the invention, the client application 5a retains existing visual and audio content on the television 15 for any channel until instructed to change this content by a new incoming event packet 50 or viewer interactivity. In this way, unlike video channels, slideshow channels always present visual content to the viewer regardless of whether any event packets 50 for that channel are being received by the client application 5a.

In one embodiment of the invention, additional interactive functions contained in the event packet 50 enable the viewer to access a third party application, access an external web site, freeze the frame, access additional functions including a text search facility, or retrieve external content, as discussed in more detail below with reference to FIG. 10.

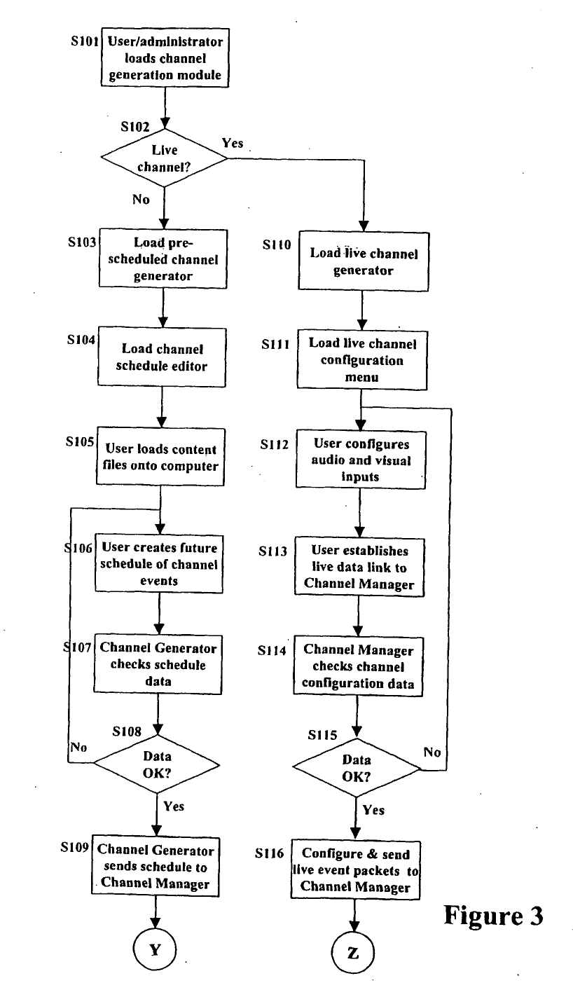

FIG. 3 shows one embodiment of the processes associated with generating channel content on the digital television broadcast system described with reference to FIGS. 1a and 1b.

Channel administrators use the channel generator 3 to define the nature and timing of content to be presented on each channel. At S101, the channel administrator loads the channel generator application on a computer. The channel generator may reside on the local computer or be accessed remotely via a network connection. On being loaded, the channel generator 3 presents the channel administrator with the option of configuring a live or pre-scheduled channel at S102.

If a pre-scheduled channel is selected the channel generator loads the pre-scheduled channel generator at S103, which then presents the administrator with a channel schedule editor at S104. The administrator may then edit an existing channel schedule or build a new schedule for a particular channel. The channel schedule editor enables channel administrators to pre-prepare a program schedule of content for that channel by defining a sequence of time-stamped event packets as described above in relation to FIG. 2. For each event packet, the administrator defines the time at which it is to be presented, the passive content to be presented at that time, the interactive functionality to be made available and the interactive content to be made available for each interactive function.

For pre-scheduled channels, the channel administrator defines event packet timestamps when building a channel schedule using the pre-scheduled channel generator. The channel manager can then broadcast individual event packets in advance so that they are received by the client application on the digital decoder ahead of the time at which they are to be processed. The client application then controls the digital decoder to store the event packet in memory and waits for the current time to match the timestamp before processing the packet.

This approach takes into account transmission path latency and processor variations to enable visual content on slideshow channels to remain in synchronization with audio content and for the presentation of channel content to remain in synchronisation across an entire network of digital decoders.

All content files defined in an event packet are loaded onto the local computer at S105. Pre-scheduled content files may include still images, audio, graphics, animation and text. The pre-scheduled channel generator 7 provides a user interface that enables channel administrators to directly interact with third party external applications and external multimedia devices, as discussed above.

The administrator then builds a schedule of event packets for a particular channel at S106. When editing is complete, the pre-scheduled channel generator checks the integrity of the schedule at S107. At S108 if the data is OK, the schedule, along with all associated content files, is then sent to the channel manager 4 at S109. If, at S108, the data is not OK, the schedule is not accepted, the process returns to S106 and the administrator must re-edit the schedule.

If, at S102, the administrator selects a live channel, then the live channel generator 6 is loaded at S110 and a live channel configuration user interface is presented at S111. This user interface enables channel administrators to interact with, and source, live content from directly connected external multimedia devices, as well as define required interactive functionality, as described above. The live channel generator 6 is configured to capture specific live visual content at regular intervals or in response to an external trigger from external audio and visual inputs at S112.

The administrator then establishes a live data link at S113 with the channel multiplexer 8. The channel multiplexer 8 then checks the channel configuration data at S114 to confirm that the content to be received from the live channel generator 6 is acceptable. If not, at S115, the administrator is required to reconfigure the live channel. If the configuration is acceptable, then the channel multiplexer 8 indicates to the live channel scheduler 6 to start sending content. The live channel generator then constructs correctly formatted event packets and sends them through to the channel multiplexer via the live data link at S116. Captured visual content could include stills captured from a digital camera 20 or video camera 21 or a captured slide from a presentation application such as PowerPoint (RTM).

According to embodiments of the present invention, both the live channel generator and the pre-scheduled channel generator may include audio in a slideshow channel via two different methods. Following the first method, and again referring to FIG. 1b, the live channel generator and pre-scheduled channel generator capture and construct audio files sourced either from directly connected multimedia devices including live audio 22 and recorded audio 23 or from a third party external application 24 or third party web site 25. In this case, the audio files are included in content event packets along with still images and other multimedia content and broadcast on a content data channel 26. Following the second method, audio is broadcast continuously on a separate audio channel and is either generated by the channel generator and passed through to the digital broadcast system 2 via a content audio channel 27, or generated by a third party audio provider 17 and passed through to the digital broadcast system 2 via a third party audio channel 28.

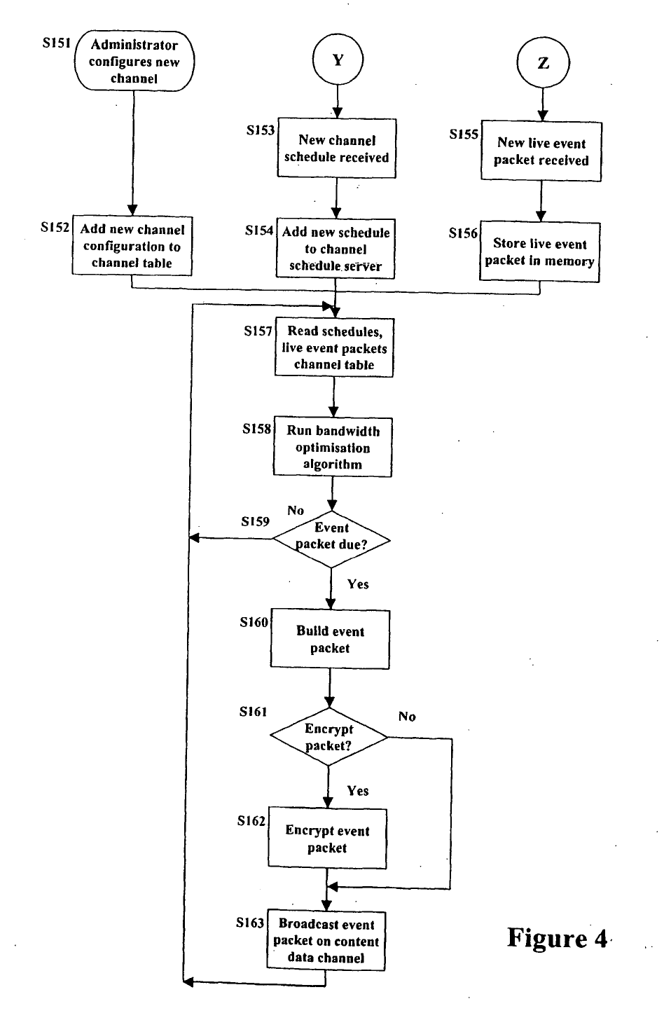

FIG. 4 shows a flowchart for the operation of the channel manager 4 described above with regard to FIGS. 1a and 1b above. The channel manager 4 provides a centrally located computer application that receives channel content and schedules sent by all channel generators 3, constructs correctly formatted event packets from this content, and multiplexes all event packets onto one or more content data channels 26.

At S151, administrators of the system can use the channel manager 4 to configure and monitor all slideshow channels on the interactive slideshow channel system 1. The channel manager 4 provides the network administrator with a user interface to establish new channels at S152. For each new channel added to the system, the network administrator establishes a new record in a channel information table, discussed below, and then configures default parameters for each channel. The channel information table is replicated in and used by the client application 5a. Fields configured may include:
Channel identifier: Unique channel identification code
Channel name: Name of the channel
Channel description: A text description of the channel used by the client application 5a on the welcome screen when the channel is first loaded
Default audio channel: Audio channel activated when channel is first loaded
Content data channel: The content data channel 26 that the client application 5a tunes to search for event packets
Priority level: The relative priority level for the channel
Available bandwidth: The total average bandwidth able to be consumed by the channel
Encryption: Whether event packets are to be encrypted

At S153, the schedule manager 9 receives new schedules sent through by dispersed pre-scheduled channel generators 7. When a new schedule is received, it is stored along with all other active channel schedules in the channel schedule server at S154.

The channel multiplexer 8 also receives newly formatted event packets from dispersed live channel generators 6. When a new event packet is received at S155, the channel multiplexer 8 stores all received live packets in event packet storage memory at S156.

The channel manager 4 runs steps S157 to S163 on a continuous cycle. The channel multiplexer 8 reads the contents of the channel information table, all active channel schedules in the channel schedule database and all event packets in the event packet memory at S157. This information is then used as inputs into the bandwidth optimisation algorithm at S158, which is run simultaneously for each connected content data channel 26. At S158, the bandwidth optimisation algorithm determines which should be the next event packet to be queued on each content data channel 26 and when that event packet should be added to the queue. The bandwidth optimisation algorithm described above seeks to ensure that all event packets arrive at the client application before their timestamp, but as close to their timestamp as possible to minimize viewer delays for newly selected channels. The bandwidth optimisation algorithm also seeks to optimise and smooth bandwidth usage for each content data channel 26.

Should, at S159, no event packet be due to be sent, the channel multiplexer 8 continually loops to read all inputs again until the situation changes. At S159, once an event packet is due to be sent then depending on the source of the identified packet, the channel multiplexer 8 either builds an event packet based on information contained in a channel schedule (for pre-scheduled channels) or retrieves the event packet from event packet memory (for live channels).

The channel multiplexer 8 then checks the channel information table to determine whether the event packet should be encrypted at S161 and, if so, encrypts the event packet at S162. The formatted event packet is then added to the respective content data channel 26 for broadcast through the digital broadcast system 2 to the client application 5a at S163.

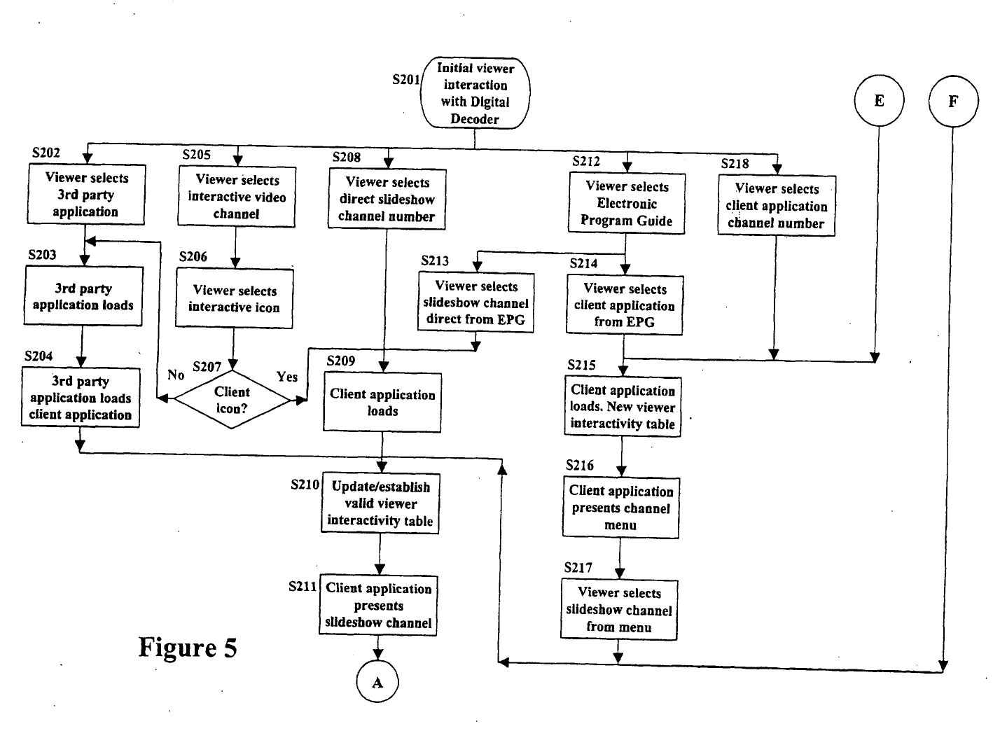

A viewer may select an individual slideshow channel via a variety of different means. One embodiment of slideshow channel selection processes on the system as shown in FIGS. 1a and 1b and referring to elements of those figures is presented in FIG. 5 and described below.

Once a digital decoder 13 is switched on, the viewer interacts with the digital decoder 13 using their remote control 16 to present content on their television 15 at S201. The viewer has a number of options. The viewer may select a third party interactive application 11, at S202, via a menu or other method, which then loads onto the digital decoder 13 at S203. Once the third party application 11 is loaded, selection options may be available for the viewer to automatically load a slideshow channel, although such options are not essential. The third party application 11 then loads the client application 5a at S204.

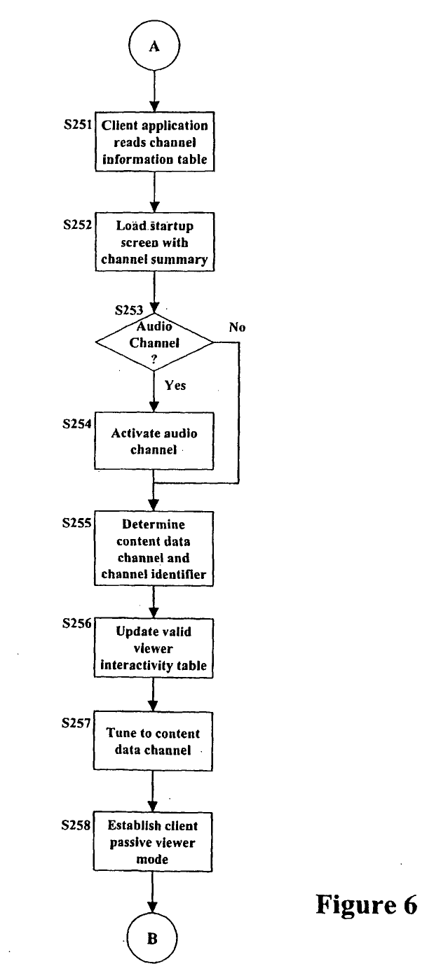

When the client application 5a is loaded, it automatically establishes (or updates) a valid viewer interactivity table at S210. The interactivity table defines, for any point in time, the interactive signals that the client application 5a will respond to. The interactivity table lists all the valid remote control options available to the viewer and accompanies these with the corresponding action to be taken by the client application 5a in response. The client application 5a then commences the process for loading a new slideshow channel at S211, as described in more detail below in relation to FIG. 6.

After S201, slideshow channels may also be selected from interactive television channels. In this case, the viewer selects an interactive television channel at S205 and then selects the interactive TV icon at S206 to access interactive functionality. At S207 the pre-programmed response to selection of the interactive TV icon takes the viewer either to a third party application at S203 where the third party application ultimately loads the slideshow channel. Alternatively, the interactive TV icon may directly lead to the client application 5a being loaded at S209.

After S201, a slideshow channel may also be selected directly from a video channel through a dedicated channel number at S208. In this case, at S209 the client application 5a loads and then establishes a valid viewer interactivity table at S210 and commences the slideshow channel loading process at S211.

Additionally, after S201, the viewer may select a slideshow channel through an electronic program guide (EPG). In this case, the viewer first selects and loads the EPG at S212. From the EPG, the viewer may directly select a sideshow channel from the EPG menu at S213. In this case the client application 5a loads at S209 and then establishes a valid viewer interactivity table at S210 and commences the slideshow loading process at S211, as described above.

Alternatively, from the EPG, the viewer may select the client application 5a at S214. In this case, the client application 5a loads at S215, establishes a valid viewer interactivity table based on information contained in the channel information table, which is broadcast as part of the client application 5a, and then presents the viewer with a menu of available slideshow channels at S216. Once the viewer has selected a slideshow channel from the menu at S217 the client application 5a updates the valid viewer interactivity table at S210 and commences the slideshow channel loading process at S211, as described above.

The viewer may also select the client application directly via a channel number from video at S218. In this case, the client application 5a loads at S215, establishes a valid viewer interactivity table and then presents the viewer with a menu of available slideshow channels at S216. Once the viewer has selected a slideshow channel from the menu at S217, the client application 5a updates the valid viewer interactivity table at S210 and commences the slideshow channel loading process at S211, as described above.

When the viewer has selected an individual slideshow channel via one of the available methods, the client application 5a commences a slideshow channel loading process. A slideshow channel loading process according to an embodiment of the invention, using the system of the FIGS. 1a and 1b and referring to the elements thereof, is presented in FIG. 6 and described below.

Once a slideshow channel has been selected, as described in regard to FIG. 5 above, the client application 5a immediately reads the channel information table, and extracts the relevant data for that channel at S251. As there is no residual content for the newly selected channel, the client application 5a must wait for a new event packet before having new content to present to the viewer. As this may involve a delay (which may be a number of seconds), the interactive client application 5a presents a welcome screen to the viewer that includes information on the channel extracted from the channel information table at S252.

The client application 5a also checks the channel information table to determine whether there is a default audio channel assigned for the slideshow channel at S253. If so, then the default audio channel is activated at S254. When the audio is activated, or if there is no default audio channel, the client application 5a then reads the channel information table to determine the content data channel 26 on which the event packets for that channel are being broadcast and also the channel identifier that it should use to filter out relevant packets from the multiplexed channel at S255. The client application 5a then updates the valid viewer interactivity table at S256 and then, at S257, tunes to the assigned content data channel 26 to wait for the next event packet with a matching channel identifier. The client application 5a also establishes the channel in passive viewer mode at S258.

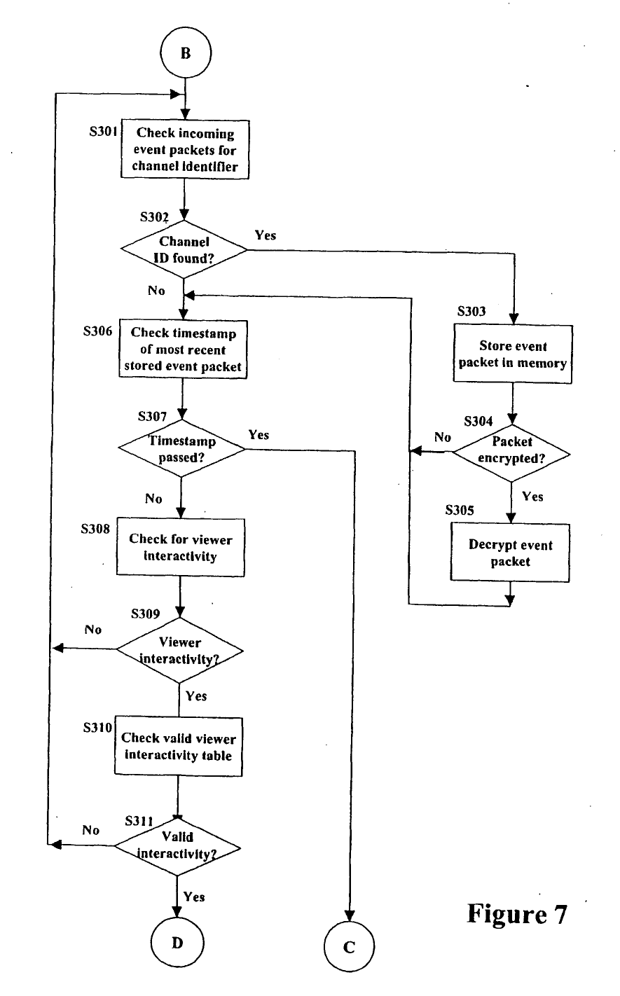

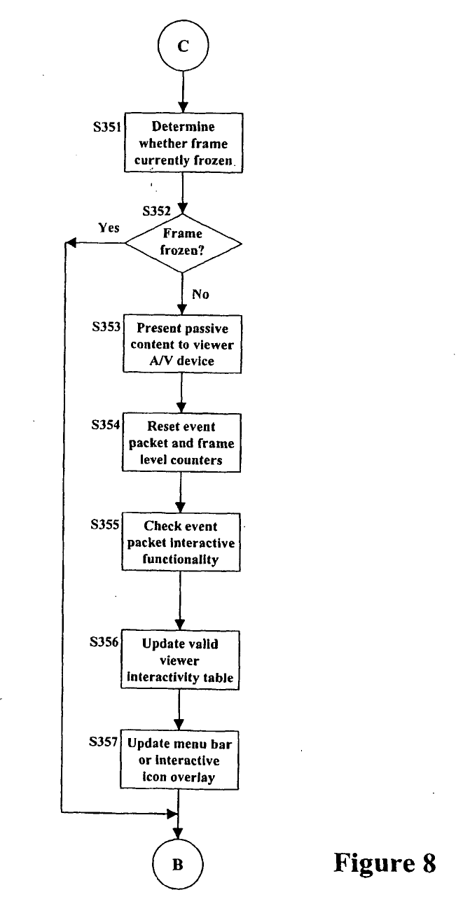

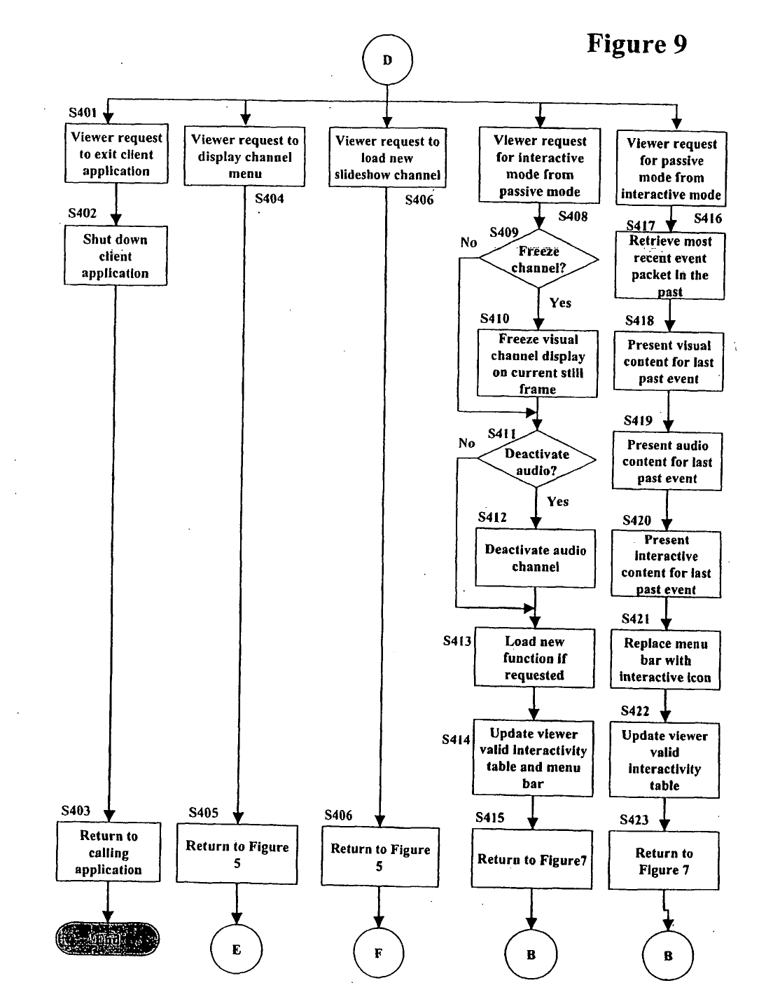

Once a slideshow channel has been selected and the slideshow channel loading process has been completed, the client application 5a initiates the main client application process, which receives and processes incoming event packets and responds to viewer interactivity through the remote control 16. One embodiment of a possible main client application process on the system described above in relation to FIGS. 1a and 1b, and referring to the elements thereof, is presented in FIG. 7 and described, below.

The client application 5a completes steps S301 to S309 on a continual basis. These steps may alternatively be completed via parallel processes. At S301, after the slide show channel is loaded, as described above in relation to FIG. 6, the client application 5a checks all incoming data on the assigned content data channel 26 for event packets that include the channel identifier corresponding to that channel. If a matching event packet is received at check step S302, then the event packet is stored in memory at S303. The client application 5a then refers to the channel identification table to determine whether the event packet is encrypted at S304 and whether that decoder is authorised to receive the channel. If so, the event packet is decrypted at S305.

Once the event packet is decoded, if necessary, the timestamp of the most recently received event packet is checked by the client application 5a at S306. If the timestamp matches or exceeds the current time, then the client application initiates event packet processing, as described with reference to FIG. 8 below.

If the timestamp has not been passed, the client application 5a checks for viewer interactivity via the remote control 16 at S308. If viewer interactivity is detected at S309, then the client application 5a checks the valid viewer interactivity table to determine whether the interactive input is valid at S310. If, at S311, the interactivity is determined valid, the client application 5a initiates the viewer interactivity processes as described with reference to FIGS. 9, 10, and 11 below. If, at S311, the interactive input is invalid, then the client application ignores the viewer input, and the process returns to S301 to check new packets. In the current embodiment of the invention, the initiation of viewer interactivity may result in an instruction for the client application to temporarily halt the processing of event packets. As a result the channel freezes and maintains the passive content and interactive functionality in the packet provided at the time at which interactivity commenced. This feature is provided whether the content is live or prescheduled, as the receiver does not differentiate between the two types of packet. The channel continues to be frozen until interactivity is cancelled by the viewer or some other means.

When the current time matches or exceeds the timestamp of a newly received event packet (at step S307 described with reference to FIG. 7, above), the client application initiates event packet processing. One embodiment of event packet processing in the system of FIGS. 1a and 1b and referring to the elements described above, is presented in FIG. 8 and described below.

On commencing event packet processing, the client application 5a first determines whether the channel is currently frozen as a result of the channel being in interactive mode at S351. If, at S352, the channel is currently frozen, then the client application aborts processing the newly arrived event packet, as new content is not presented to the viewer for a channel in frozen mode, and returns to the client application process described with reference to FIG. 7 above.

If the channel is not frozen, then the client application reads the instructions in the passive visual content definition, passive audio content definition and passive interactivity content definition (as described above with reference to FIG. 2), and accordingly presents new passive visual and audio content on the viewer's television at S353. The client application 5a also resets the event packet and frame level counters at S354 so that they refer to the current event packet and a passive frame level 0.

The client application 5a then checks the interactive function definition in the event packet to determine the interactive functionality to be provided with that event packet at S355. The client application 5a then updates the viewer interactivity table at S356. At S357, the client application 5a updates either the menu bar, if the channel is in interactive mode, or the interactive icon overlay, if the channel is in passive mode.

A viewer uses their remote control 16 to interact with the client application 5a. On receiving new interactive viewer input, as described in FIG. 7 above, the client application checks the valid viewer interactivity table to confirm that the viewer input is valid. If the viewer input is valid, the client application initiates viewer interactivity processes in response. One embodiment of some of many possible viewer interactivity processes operating on the system described with reference to FIGS. 1 and 1b, and referring to the elements thereof, is presented in FIGS. 9 and 10 and described below.

After the process shown in FIG. 7 above, reaches ‘D’, it continues as shown in FIG. 9. A number of options are available to the interactive user. The viewer may request to exit the client application at S401. In this case, the client application is shutdown at S402 and removed from memory. The digital decoder 13 then returns the viewer to the application that originally called the client application 5a at S403.

Alternatively, the viewer may request to exit the current slideshow channel and display a menu of available slideshow channels at S404. In this case, the process returns to that described with reference to FIG. 5 above, and the client application 5a updates the valid viewer interactivity table at S215 and presents the channel menu at S216.

Further, the viewer may request to directly load a new slideshow channel at S406. In this case, the process once again returns to that described with reference to FIG. 5 above, and the client application 5a updates the valid viewer interactivity table at S210 and automatically initiates the slideshow channel loading process for the selected channel at S211.

When viewing a passive content from a channel, the viewer may select a provided interactive icon and request to interact with the client application 5a to thereby enter interactive mode at S408. In this case, the client application 5a refers to the passive interactive content definition field in the event packet (described above with reference to FIG. 2) to determine whether the channel is to be frozen on entering interactive mode at S409. If the channel is to be frozen, the client application 5a freezes the current displayed visual content on the screen and thereby freezes the channel at S410. If the channel is not to be frozen, then passive content may continue to be displayed, in addition to the requested interactive content. Whether a channel is frozen or not impacts on how new incoming event packets 50 are handled when their timestamp 52 is due as discussed above. The client application 5a also refers to the passive interactive content definition field in the event packet to determine whether audio is to be deactivated when entering interactive mode at S411. If so, the audio channel is deactivated at S412. The client application 5a also refers to the passive interactive content definition field in the event packet to determine whether an interactive function is to be loaded on entering interactive mode. If so, the function is automatically loaded at S413. The client application 5a then updates the viewer valid interactivity table and menu bars at S414. The process then returns to the client application process described with reference to FIG. 7 above.

Further, when viewing a channel in interactive mode, the viewer may request to return to passive mode, which returns them to the live slideshow channel at S416. In this case, the client application 5a first retrieves from memory the most recently received stored event packet that has a timestamp that is in the past at S417. If the channel is currently frozen, the client application 5a then refers to the corresponding passive visual content definition field and presents the passive visual content associated with this event packet at S418. If audio is deactivated, the client application 5a then refers to the corresponding passive audio content definition field. If there is a passive audio content packet in the event packet then nothing is done. If the passive audio content definition refers to an audio channel or default audio channel, then the client application 5a activates this channel accordingly at S419. The menu bar is replaced with an interactive icon at S421. The client application 5a then updates the viewer valid interactivity table at S423 and returns to the main client application 5a process discussed above with reference to FIG. 7.

Referring now to FIG. 10, the viewer may alternatively request to access a third party interactive application at S451. In this case, the viewer may exit the client application 5a either temporarily or permanently S452. If exiting permanently, the client application 5a is shutdown at S453 and the new third party application is loaded at S454 and the process ends. If exiting temporarily, the third party application 11, 24 is loaded at S455 and the current event packet and other status data are retained by the client application 5a, so that, when the viewer exits the third party application 11, 24, they return to the client application 5a. At S456, the process determines whether the channel was previously frozen (see S461 discussed below). If the channel was previously frozen, the viewer is returned to the same frozen visual, audio and interactive presentation at S462 as described below. If the channel was not frozen, the client application returns to the main client application process described above with reference to FIG. 7.

Further, in some embodiments of the invention, the viewer may request to access a third party web site 25 at S457. In this case, the client application 5a establishes a data circuit to the web site at S458 through the modem return path 31 (if available). The client application 5a then loads a web access screen such as a browser at S459. The viewer then accesses and exits the web site as requested by the viewer at S460. When the viewer has exited the web site, once again the previously displayed slide is determined at S456 and they return to either the content for the frozen event packet from which they left at S462 or to the main client application process described above with reference to FIG. 7.

Where the displayed slide channel is not already frozen in interactive mode, the viewer may request to freeze the current event packet at S461. In this case, the client application 5a freezes the visual content for the current event packet, displays it at S462, and then updates the valid viewer interactivity table at S463 and menu bar at S463 accordingly.

In some embodiments, the viewer may request the retrieval of content from an external content server at S465. In this case, the client application 5a establishes a data circuit to the remote content server at S466 through the modem return path 31 (if provided). The client application 5a then retrieves the requested content and presents it to the viewer at S467. The client application 5a then updates the valid viewer interactivity table at S463 and menu bar at S464 accordingly. The client application 5a may shutdown the modem return path 31 when viewer interactivity is completed.

The viewer may also request to access an interactive function at S468 (such as a text search facility). In this case, the client application 5a retrieves the corresponding content definition function field in the current event packet and loads the corresponding function at S469. The interactive client then updates the valid viewer interactivity table at S463 and menu bar at S464 according to the instructions in the content definition function field (described with reference to FIG. 2 above). Once the menu bar overlay is updated at S464, the process returns to that described with reference to FIG. 7 above.

The client application 5a provides viewers with an interactive function that enables them to use their remote control 16 to move the presentation between event packets and to view hidden content sent with each event packet. One embodiment of a number of these viewer interactivity navigation processes operating on the system described above with reference to FIGS. 1a and 1b and referring to the elements thereof, and providing packets as described with reference to FIG. 2 and referring to the elements thereof, is presented in FIG. 11 and described below. Further such processes may also be provided, as desired.

All event packets 50 for a particular slideshow channel are broadcast in a defined numbered sequence and, in the present embodiment, each event packet 50 includes passive content that is presented to the viewer when the timestamp 52 for that event packet 50 has expired. Each event packet 50 may also include hidden content that is broadcast as part of the event packet 50, but is only accessible if the viewer interacts with that event packet 50. For each event packet, hidden content is arranged in frame levels, where passive content for each event packet 50 is assigned as frame level 0 (passive) for that event packet 50, as discussed above.

The client application 5a provides an interactive function that allows viewers to navigate between content for different event packets 50 and frame levels. The client application 5a uses event packet 50 and frame level counters to manage navigation. When the viewer selects the interactive navigation function, the client application 5a freezes visual channel content on the current passive frame. Depending on the channel, audio may be either silenced, shifted to a new audio channel or left to continue in passive mode. The viewer is then presented with a menu bar that provides a range of navigation functionality.

At S501, the viewer may request to rewind frames, which indicates that the viewer seeks to present passive content (frame level 0) for an event packet 50 with a time stamp earlier than the one currently displayed. In this case, the client application 5a decrements the event packet counter and sets the frame level to 0, which refers to passive content for that event packet 50 at S502. The client application 5a then retrieves the event packet 50 received immediately before the one currently displayed and reads the passive visual, audio and interactive definition fields 53,54,55 to present the passive content for that event packet 50 to the viewer at 503. The client application 5a then updates the valid viewer interactivity table at S513 and menu bar at S514 and returns to the main client application process described with reference to FIG. 7.

The viewer may request to fast forward frames at S504, which indicates that the viewer is not displaying the most recent past event packet 50 and seeks to present passive content for an event packet 50 later than the one currently displayed. In this case, the client application 5a increments the event packet counter and sets the frame level to 0, which refers to passive content for that event packet 50 at S505. The client application 5a then retrieves the event packet 50 received immediately after the one currently displayed and reads the passive visual, audio and interactive definition fields 53,54,55 to present the passive content for that event packet 50 to the viewer at S506. The client application 5a then updates the valid viewer interactivity table at S513 and menu bar at S514 and returns to the main client application process as described above with reference to FIG. 7.

The viewer may request to increment frame levels at 507, which indicates that the viewer seeks to access hidden content for the currently displayed event packet 50 for one level below that currently presented, i.e. drill down through content not displayed on the passive level (frame level 0). In this case, the client application 5a increments the frame level counter at S508 and then retrieves the current event packet 50 and reads the visual, audio and interactive definition data defined for that frame level in the content definition function field 57 corresponding to the interactive navigation function, and presents the corresponding content for that frame level to the viewer at S509. The client application 5a then updates the valid viewer interactivity table at S513 and menu bar at S514 and returns to the main client application process described above with reference to FIG. 7.

Additionally, the viewer may request to decrement frame levels at 510, which indicates that the viewer seeks to access hidden content for the currently displayed event packet 50 for one level above that currently presented (i.e. returning to a level that they have previously drilled through). In this case, the client application decrements the frame level counter at S511, retrieves the current event packet 50 and reads the visual, audio and interactive definition data defined for that frame level in the content definition function field 57 corresponding to the interactive navigation function and presents the corresponding content for that frame level to the viewer at S512. The valid viewer interactivity table and menu bar are updated at S513 and S514 respectively, and the client application 5a then returns to the main client application process described above with reference to FIG. 7.

The viewer may also request to return to the passive frame level at S515, which indicates that the viewer is currently accessing hidden content for an event packet 50 and seeks to immediately return to display the passive content for the current event packet 50. In this case, the client application 5a sets the frame level counter to 0 at S516 and then reads the passive visual, audio and interactive definition data 53, 54, 55 to present the corresponding passive content to the viewer at S517. The client application 5a then updates the valid viewer interactivity table at S513 and menu bar at S514 and returns to the main client application process described above with reference to FIG. 7.

The viewer may also request to play digital audio at S518, which indicates that the viewer is currently accessing a frame level in an event packet 50 that has an associated digital audio content file and seeks to play that audio. In this case, the client application 5a reads either the passive audio definition field 53 or the content definition function field to retrieve and play the corresponding audio level depending on the current frame level at S519. The client application 5a then updates the valid viewer interactivity table at S513 and menu bar at S514 and returns to the main client application described above with reference to FIG. 7.

The viewer may further request to stop digital audio at S520, which indicates that the viewer is currently listening to a digital audio content file associated with a frame level in an event packet 50 and seeks to terminate the audio file. In this case, the client application terminates the digital audio file at S521 and then updates the valid viewer interactivity table at S513 and menu bar at S514 and returns to the main client application process described above with reference to FIG. 7.

The present invention has been described above with the aid of functional building blocks illustrating the performance of specified functions and relationships thereof. The functional building blocks have been arbitrarily defined herein while describing embodiments of the invention. Alternative definitions can also be defined; the invention extends to any such alternative definitions. It will be seen that the functional building blocks can be implemented by application specific integrated circuits, discrete components, processors executing appropriate software and the like or any combination thereof.

In the claims:

1. A method of broadcasting an image channel over a digital television broadcast network for output by a multimedia device, the method including broadcasting a plurality of discrete event packets of data, each packet including data representing at least one of:
passive content to be output by the multimedia device; and
interactive content to be output by the multimedia device on request by a viewer of the device,
wherein each packet further includes a time stamp for determining when the content should be made available for output to the multimedia device.

2. A method according to claim 1, wherein the interactive content provides interactive functionality, which is variable from packet to packet.

3. A method according to claim 2, wherein the interactive content includes an interactive content definition, which defines the interactive functionality available for the packet.

4. A method according to claim 3, wherein the interactive functionality available for the packet is to allow content of previously broadcast packets to be available for output by the multimedia device on request by the viewer of the multimedia device.

5. A method according to claim 1, wherein the plurality of packets includes at least one packet including data representing at least passive content and at least one packet including data representing at least interactive content.

6. A method according to claim 1, wherein each of the plurality of packets includes data representing passive content.

7. A method according to claim 1, wherein the passive content is to be output by the multimedia device from when it is made available.

8. A method according to claim 1, wherein the passive content includes at least part of a still image to be displayed by the multimedia device.

9. A method according to claim 8, wherein the at least part of a still image of a packet is to be overlayed on at least part of an image of a previous packet.

10. A method according to claim 1, wherein the interactive content includes at least a part of at least one still image.

11. A method according to claim 1, wherein the interactive content provides a plurality of levels of separately selectable interactive content to be output on request by a viewer of the multimedia device.

12. A method according to claim 1, wherein a separate audio channel is also broadcast over the broadcast network, and the time represented by the time stamp of each packet is synchronised with a point in time of the separate audio channel.

13. A method according to claim 1, wherein content included in at least one packet includes data representing audio content to be output by the multimedia device.

14. A method according to claim 1, wherein the plurality of packets are broadcast sequentially and each packet is broadcast only once.

15. A method according to claim 1, wherein the time stamp associated with an event packet represents a time after the event packet is broadcast.

16. A method according to claim 1, wherein at least some of the broadcast content is received from at least one live source.

17. A method according to claim 16, wherein the time stamp associated with content from the at least one live source represents a time before the packet is broadcast.

18. A method according to claim 1, wherein the content of a packet is to be made available for output by the multimedia device until a new packet is received and a time represented by the time stamp of the new packet is reached.

19. A method according to claim 1, further including the step of broadcasting data representing a client application to be used to process the packets to make them available for output by the multimedia device and support viewer interactivity.

20. A method according to claim 19, wherein the client application is dynamically configurable to enable interactive functionality to be altered on a packet by packet basis.

21. A method according to claim 1, wherein multiple still image channels are multiplexed before being broadcast.

22. A method according to claim 1, wherein each packet includes a channel identifier that identifies with which particular channel the packet is associated.

23. A method of generating an image channel for broadcast on a digital television broadcast system for output by a multimedia device, the method including:
receiving image channel content;
defining content as at least one of passive content and interactive content, wherein the passive content is configured to be output by the multimedia device, and the interactive content is configured to be output by the multimedia device on request by a viewer of the multimedia device;
splitting the content into discrete units;
associating the content of each unit with time stamps for determining a desired time for the content of the unit to be made available for output to the multimedia device; and
generating and outputting for broadcast discrete event packets of data, each packet containing data representing at least one unit of at least one of passive and interactive content, and the associated time stamp.

24. A method according to claim 23, wherein the interactive content provides interactive functionality, which is variable from packet to packet.

25. A method according to claim 24, wherein the interactive content includes an interactive content definition, which defines the interactive functionality available for the packet.

26. A method according to claim 25, wherein the interactive functionality available for the packet is to make content of packets with a time stamp representing an earlier time than that of the most recent packet available for output by the multimedia device on request by the viewer of the multimedia device.

27. A method according to claim 23, wherein the interactive content represents multiple levels of separately selectable interactive content, to be output on request from a viewer of the multimedia device.

28. A method according to claim 23, wherein the content of at least one of the packets includes data representing audio content to be output by the multimedia device.

29. A method according to claim 23, wherein a plurality of slide show channels are generated, and each packet includes a channel identifier identifying the channel with which the packet is associated.

30. A method according to claim 23, wherein the associated time stamp represents a time after the packet is to be broadcast.

31. A method according to claim 23, wherein at least some of the broadcast content is received from at least one live source.

32. A method according to claim 31, wherein the time stamp associated with content from the at least one live source represents a time before the packet is to be broadcast.

33. A method of generation of a slide show channel according to claim 23.

34. An image channel generation system for a digital television broadcast network for output by a multimedia device, the system including at least one generating means, each generating means including:
a receiving component for receiving image channel content;
a defining component for defining content as at least one of passive content and interactive content, wherein the passive content is configured to be output by the multimedia device, and the interactive content is configured to be output by the multimedia device on request by a viewer of the multimedia device;
a splitting component for splitting the content into discrete units;
an association component for associating the content of each unit with a time stamp for determining a desired time for the content of the unit to be made available for output to the multimedia device; and
a generating component for generating discrete event packets of data, each packet containing data representing at least one unit of at least one of passive and interactive content, and the associated time stamp.

35. A system according to claim 34, including a plurality of generating means, each generating means for generating a different image channel.

36. A system according to claim 35, further including channel manager means configured to receive packets from the plurality of generating means representing a plurality of image channels, and multiplex the channels, incorporating a channel identifier into each packet that identifies the particular channel with which the packet is associated.

37. A system according to claim 34, further including a digital television broadcast network to broadcast the packets.

38. A method of processing an image channel from a digital television broadcast network for output by a multimedia device to a viewer of the channel, the method including:
receiving a plurality of data event packets, each packet including data representing a time stamp and at least one of passive content and interactive content, wherein the passive content is configured to be output by the multimedia device, and the interactive content is configured to be output by the multimedia device on request by a viewer of the multimedia device;
determining the time that the content of each packet should be made available for output using the time stamp; and
making the content of the packet of the image channel available for output to the viewer at the determined time.

39. A method according to claim 38, wherein the interactive content provides interactive functionality, which is variable from packet to packet.

40. A method according to claim 39, wherein the interactive content includes an interactive content definition, which defines the interactive functionality available for the packet.

41. A method according to claim 39, wherein previously processed packets are stored, and wherein the interactive functionality available for the packet is to make content of previously broadcast packets available for output by the multimedia device on request by the viewer of the multimedia device.

42. A method according to claim 38, wherein the passive content of a packet is output from when it is made available until a new packet is received and a time represented by the time stamp of the new packet is reached.

43. A method according to claim 38 wherein each of the plurality of packets includes data representing passive content.

44. A method according to claim 38, wherein the passive content includes at least a part of a still image.

45. A method according to claim 44, wherein the at least part of a still image of a packet is overlayed on the at least part of an image of a previously output packet.

46. A method according to claim 38, wherein multiple packets for multiple channels are received and a channel identifier in each packet is processed and only content from packets with a particular channel identifier are output for display.

47. A method according to claim 46, wherein a viewer of the image channels chooses the particular channel to view.

48. A method according to claim 38, wherein the interactive content includes at least a part of at least one still image.

49. A method according to claim 48, wherein the interactive content provides a plurality of levels of separately selectable interactive content to be output on request by the viewer of the device.

50. A method according to claim 38, further including receiving a separate audio channel and outputting the passive content in synchronicity to the audio channel.

51. A method according to claims 38, wherein the content includes data representing audio content.

52. A method according to claim 38, further including receiving a client application for processing the image channel packets and supporting viewer interactivity.

53. A method according to claim 38, wherein packets are made available at the time represented by the time stamp.

54. A method according to claim 38, wherein packets in which the time stamp represents a time that has already passed are made available for output immediately.

55. A method of processing an image channel from a digital television broadcast network for output by a multimedia device to a viewer of the channel, the method including:
receiving a plurality of data event packets, each packet including data representing a time stamp and at least one of passive content and interactive content, wherein the passive content is configured to be output by the multimedia device, and the interactive content is configured to be output by the multimedia device on request by a viewer of the multimedia device;
determining the time that the content of each packet should be made available for output using the time stamp; and
making the content of the packet of the image channel available for output to the viewer at the determined time
wherein the method further includes the method of claim 33.

56. A receiving device for receiving an image channel broadcast on a digital television broadcast network to be output on a multimedia device, the receiving device including:
receiving means for receiving discrete event data packets, each packet including a time stamp and at least one of passive content and interactive content, wherein the passive content is to be made available for output by the multimedia device, and the interactive content is to be made available for output by the multimedia device on request by a viewer of the device;
processing means for processing the discrete event data packets; and
outputting means for outputting the content to be available for output by the multimedia device to a viewer at the time indicated by the associated time stamp.

57. A receiving device according to claim 56, further including interactive means for receiving interactive input from a viewer of the multimedia device and controlling the outputting means to output at least a part of the interactive content of available content of a received packet.

58. A receiving device according to claim 57, wherein the interactive content provides interactive functionality and a plurality of levels of interactive content, and the processing means is configured to control the output of the selected level of interactive content, chosen by the viewer via the interactive means.

59. A receiving device according to claim 56, wherein the receiving means is configured to receive multiple packets for multiple channels and the processing means is configured to process a channel identifier in each packet and control the output means to output only content of packets having a particular channel identifier.

60. A receiving device according to claim 59, wherein the interactive means is configured to receive a choice of the particular channel desired to be viewed and control the processing means to process packets having the appropriate channel identifier.

61. A receiving device according to claim 57, further including storage means, for storing previously received packets for subsequent further processing, and wherein the processing means is configured to output content for a previously received packet on selection by the viewer via the interactive means.

62. A receiving device according to claim 56, wherein each packet includes passive content in the form of at least a part of a still image, and the outputting means is configured to output for display the at least part of the still image of a packet until a new packet is processed and output.

63. A receiving device according to claim 56, wherein the receiving means is configured to receive an audio channel and the processing means is configured to process the audio channel and output the content in synchronicity to the audio channel based on a timestamp.

64. A receiving device according to claim 56, wherein the outputting means is configured to output audio included in the content of at least one of the packets.

65. A receiving device according to claim 56, wherein the processing means is configured to control the outputting means to make the content of a packet available for output at a time represented by the time stamp of the packet.

66. A receiving device according to claim 56, wherein the processing means is configured to control the outputting means to make the content of a packet, for which the time represented by the time stamp has already passed, available for output immediately.

67. A receiving device according to claim 56, wherein the receiving means is configured to receive a client application to be executed by the processing means.

68. A receiving device according to claim 56, wherein the receiving device is a digital television decoder.

69. A storage medium containing processor readable code to control a processor to carry out the method of claim 1.

70. A receiving device for receiving a channel broadcast on a digital broadcast network, the device including:
receiving means for receiving discrete event packets of data, each packet including content and an associated time stamp;
processing means for processing the discrete event packets; and outputting means for making the content available for display by a multimedia device at the time indicated by the associated time stamp.

71. A method of processing digital broadcast channels received from a digital broadcast network for presentation, the method including:
receiving a plurality of event packets of data, each event packet including data representing content and an associated time stamp; and
outputting for display the content at the time indicated by the associated time stamp.

72. A method of broadcasting a channel over a digital broadcast network, the method including broadcasting a plurality of discrete event packets of data, each packet including data representing:
content to be made available for output by a multimedia device; and
an associated time stamp for determining when the content should be made available for output to the multimedia device.

73. A method of configuring a receiving device for receiving a channel broadcast on a digital network, the method including:
receiving client application software at the receiving device;
installing the client application software on the receiving device; and
running the client application software on the receiving device,
wherein the client application software includes instructions to carry out the method according to claim 38.

74. A method of optimising bandwidth in a digital broadcast network broadcasting multiple channels, the method including:
receiving a plurality of discrete event packets of data, each event packet including data representing passive content for a channel, and an associated time stamp for determining when the content should be made available for output to a viewer by a multimedia device;
determining the size of each event packet and a time represented by the associated time stamp; and
determining an optimum broadcast time for each event packet, wherein the optimum broadcast time is the latest time that the event packet can be broadcast and be processed for output to a viewer by the multimedia device before the time represented by the associated time stamp.
